(19) United States
(12) Patent Application Publication
(10) Pub. No.: US 2026/0357865 A1
(43) Pub. Date: Nov. 12, 2026

(54) BRAKE DEVICE FOR VEHICLE

(71) Applicant: HYUNDAI MOBIS CO., LTD., Seoul (KR)

(72) Inventor: Si Won PARK, Yongin-si (KR)

(73) Assignee: HYUNDAI MOBIS CO., LTD., Seoul (KR)

(21) Appl. No.: 19/316,339

(22) Filed: Sep. 2, 2025

(30) Foreign Application Priority Data
Oct. 18, 2024 (KR) 10-2024-0143040

(51) Int. Cl. F16D 65/16; F16D 121/04; F16D 121/24; F16D 125/40

(52) U.S. Cl. CPC F16D 65/16; F16D 2121/04; F16D 2121/24; F16D 2125/40

(57) ABSTRACT

A brake device for a vehicle includes a cylinder part, a motor part that generates rotational power, a screw shaft that is disposed inside the cylinder part and receives the rotational power of the motor part to be axially rotated, a nut part coupled to the screw shaft and reciprocating in an axial direction of the screw shaft according to rotation of the screw shaft, a sleeve part disposed between the cylinder part and the screw shaft, a piston part coupled to the nut part and including a head portion reciprocating inside the sleeve part according to reciprocal movement of the nut part, a bearing part disposed inside the cylinder part and coupled to the screw shaft, and a support part that is screw-coupled to the screw shaft, comes into contact with the bearing part, and supports the screw shaft to be axially rotatable.

### CROSS-REFERENCE TO RELATED APPLICATION

This application claims the benefit under 35 U.S.C. § 119(a) of priority to Korean Patent Application No. 10-2024-0143040 filed on Oct. 18, 2024, in the Korean Intellectual Property Office, the entire disclosure of which is incorporated herein by reference for all purposes.

### BACKGROUND

### 1. Technical Field

Exemplary embodiments of the present disclosure relate to a brake device for a vehicle, and more particularly, to a brake device for a vehicle capable of converting the rotational motion of a screw shaft, which is rotated by receiving rotational force from a motor, into linear motion of a piston.

### 2. Related Art

In general, due to the characteristics of an electronic brake device for a vehicle, a device is required that converts the rotational motion of the motor into the linear motion of the piston inside a cylinder to generate braking fluid pressure.

As a device that converts the rotational motion of a motor into linear motion, a ball screw device is applied to the electric brake device, which includes a screw shaft that receives the rotational power of the motor and rotates, a nut connected to the screw shaft via a ball and moves in the axial direction of the screw shaft, and a piston connected to the nut and pressurizes the operating fluid inside the cylinder.

In the past, there were problems such as damage to the joint with the motor, deterioration of system performance, vibration, and noise due to resonance occurring in the ball screw device during the process of generating braking fluid pressure. In addition, during the process of aligning a bearing part, bearing part may come into contact with a sleeve part, which may cause impact noise and insufficient shaft alignment compensation. This may result in reduced efficiency of the vehicle braking system and cause vibration and noise. Therefore, there is a need to improve the problems.

The background technology of the present disclosure is disclosed in Korean Patent Application Publication No. 10-2021-0064367 (published on Jun. 2, 2021, entitled “Hydraulic unit for hydraulic vehicle braking system”).

### SUMMARY

Various embodiments are directed to a brake device for a vehicle capable of securing a fastening force between a support part and a screw shaft by screw-connecting the support part to the screw shaft.

Various embodiments are directed to a brake device for a vehicle capable of increasing the connection area between the support part and the screw shaft.

Various embodiments are directed to a brake device for a vehicle capable of preventing the screw connection between the support part and the screw shaft from loosening when the piston part moves in the main operating direction.

Various embodiments are directed to a brake device for a vehicle that that prevents friction between the sleeve part and the bearing during rotation, thereby reducing vibration and noise.

In an embodiment of the present disclosure, a brake device for a vehicle may include a cylinder part, a motor part that generates rotational power, a screw shaft that is disposed inside the cylinder part and receives the rotational power of the motor part to be axially rotated, a nut part coupled to the screw shaft and reciprocating in an axial direction of the screw shaft according to rotation of the screw shaft, a sleeve part disposed between the cylinder part and the screw shaft, a piston part coupled to the nut part and including a head portion reciprocating inside the sleeve part according to reciprocal movement of the nut part, a bearing part disposed inside the cylinder part and coupled to the screw shaft, and a support part that is screw-coupled to the screw shaft, comes into contact with the bearing part, and supports the screw shaft to be axially rotatable.

The support part may include a support bolt, and the support bolt may be inserted into a coupling part of the screw shaft and is screw-connected to a inner surface of the coupling part.

When the support bolt is screw-connected to the coupling part, a front end of the support bolt may be spaced apart from an innermost bottom surface of the coupling part.

When the screw shaft rotates and the piston part moves forward toward the sleeve part, the support part may be rotatable in a direction in which the support part is fastened to the screw shaft.

When the screw shaft rotates in a left screw direction and the piston part moves forward toward the sleeve part, the support part may rotate in the left screw direction and is screw-connected to the screw shaft, and when the screw shaft rotates in a right screw direction and the piston part moves forward toward the sleeve part, the support part may rotate in right screw direction and is screw-connected to the screw shaft.

The bearing part may include an outer ring part that is in contact with an inner surface of the cylinder part and in contact with the sleeve part, and an inner ring part that is rotatable on an inner side of the outer ring part, in contact with the screw shaft, and spaced apart from the sleeve part.

The sleeve part may include a first facing portion facing the outer ring part and in contact with the outer ring part, and a second facing portion facing the inner ring part and spaced apart from the inner ring part.

The first facing portion and the second facing portion may be formed in steps.

The sleeve part may connect the first facing part and the second facing part and include a transition portion disposed to gradually separate from the bearing part as goes from the first facing portion toward the second facing portion.

The brake device for a vehicle may further include a reaction force part that presses the sleeve part toward the bearing part, including a first side supported by the cylinder part and a second side in contact with the sleeve part.

According to the present disclosure, because the support part is screw-connected to the screw shaft, the fastening force between the support part and the screw shaft can be secured.

According to the present disclosure, because the support part includes a support bolt that is screw-connected to a coupling part, the fastening area between the support part and the screw shaft can be increased, thereby achieving fastening strength.

According to the present disclosure, the screw fastening between the support part and the screw shaft can be prevented from loosening when the piston part moves in the main operating direction.

According to the present disclosure, because the rotating part of the bearing part and the sleeve part are arranged to be spaced apart, friction with the sleeve part can be prevented when the bearing part rotates, and vibration, noise, etc. caused by this can be reduced.

### BRIEF DESCRIPTION OF THE DRAWINGS

FIG. 1 is a cross-sectional view illustrating a brake device for a vehicle according to an embodiment of the present disclosure.

FIG. 2 is a perspective view of a cylinder part according to an embodiment of the present disclosure, viewed from one direction.

FIG. 3 is a perspective view of the cylinder part of FIG. 2, viewed from another direction.

FIG. 4 is a cross-sectional view schematically illustrating a brake device for a vehicle according to an embodiment of the present disclosure.

FIG. 5 is an enlarged cross-sectional view of a periphery of a vibration reduction part according to an embodiment of the present disclosure.

FIG. 6 is an enlarged cross-sectional view of a periphery of a support part and screw shaft according to an embodiment of the present disclosure.

FIG. 7 illustrates an operating state in which a piston part advances inside a cylinder part in a brake device for a vehicle according to an embodiment of the present disclosure.

FIG. 8 illustrates an operating state in which a piston part retreats inside a cylinder part in a brake device for a vehicle according to an embodiment of the present disclosure.

### DETAILED DESCRIPTION

Hereinafter, a brake device for a vehicle according to the present disclosure is described in detail with reference to the accompanying drawings through various exemplary embodiments. It should be considered that the thickness of each line or the size of each component in the drawings may be exaggeratedly illustrated for clarity and convenience of description.

In addition, terms to be described below have been defined by taking into consideration their functions in the present disclosure, and may be different depending on a user or operator's intention or practice. Accordingly, such terms should be interpreted based on the overall contents of this specification.

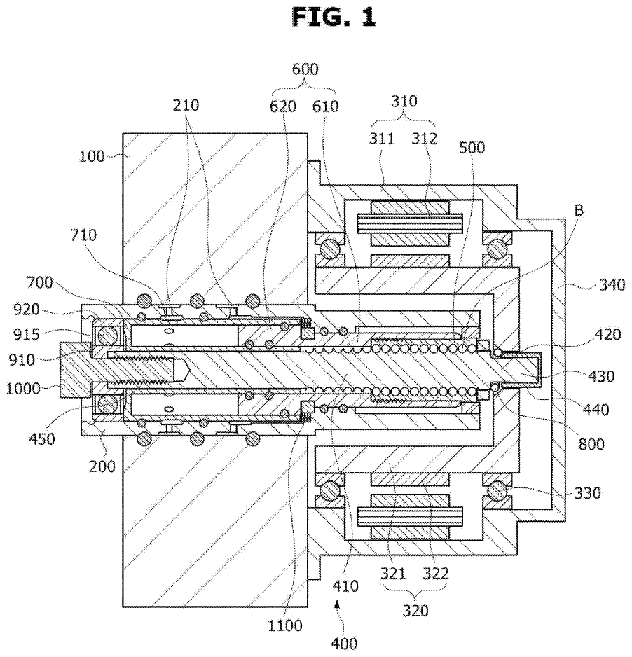

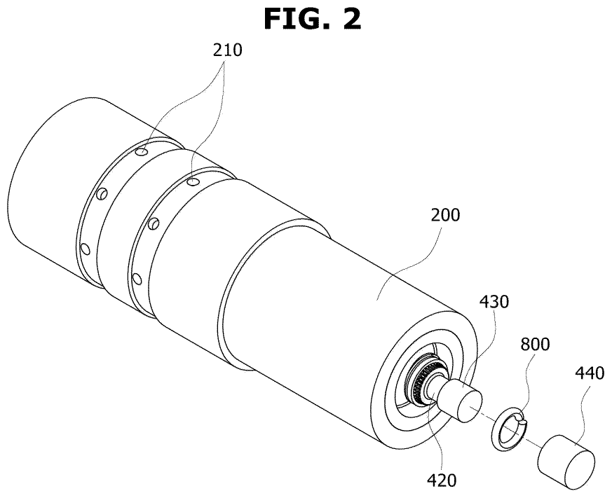

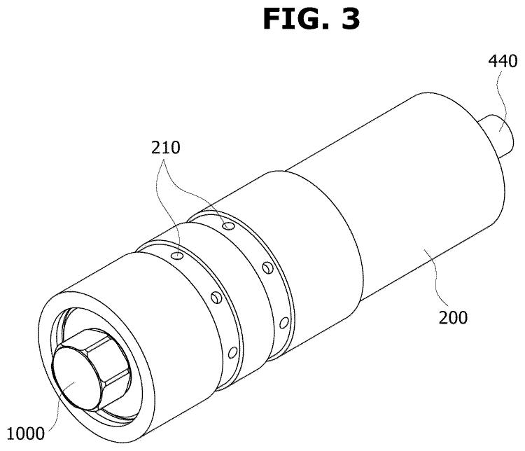

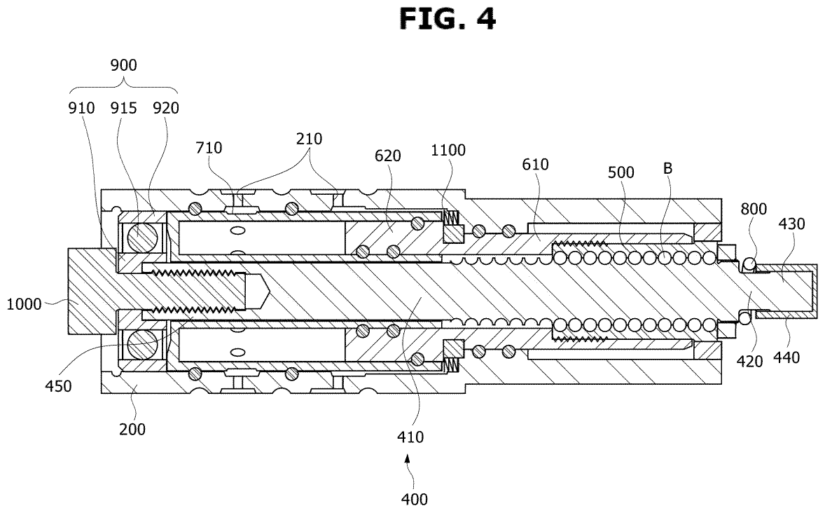

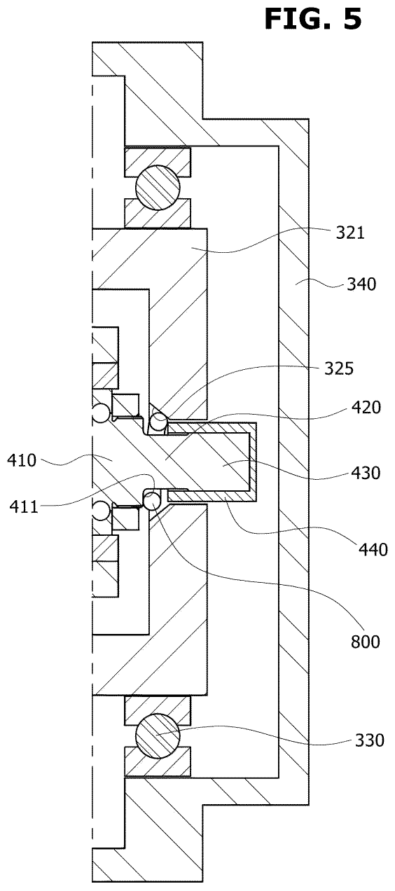

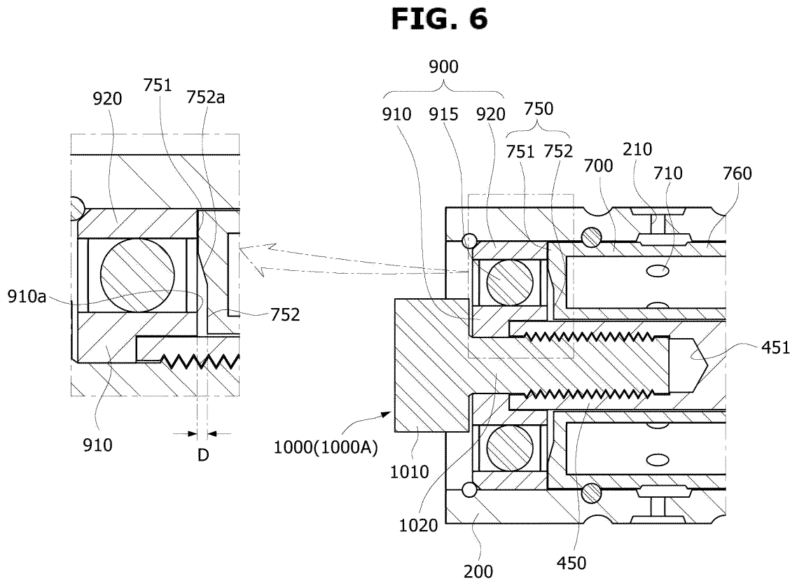

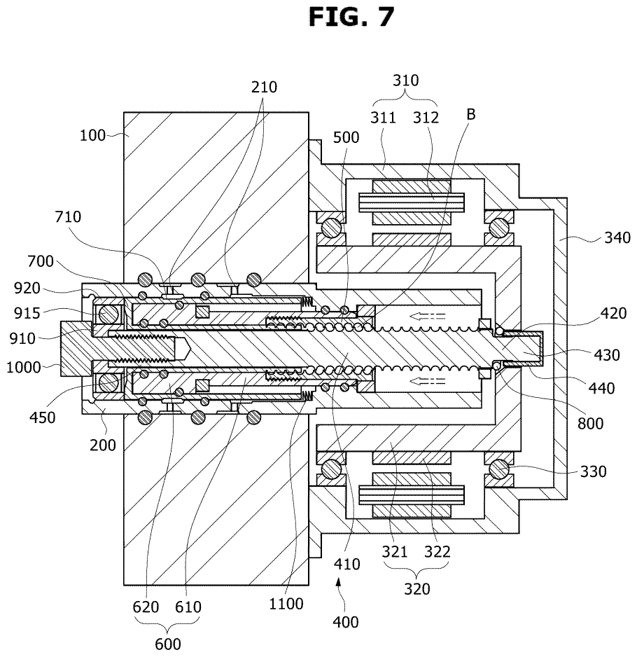

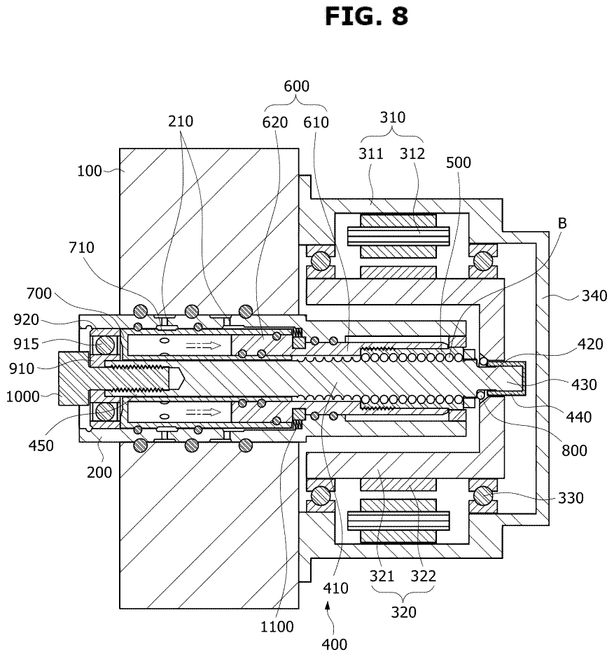

FIG. 1 is a cross-sectional view illustrating a brake device for a vehicle according to an embodiment of the present disclosure. FIG. 2 is a perspective view of a cylinder part according to an embodiment of the present disclosure, viewed from one direction. FIG. 3 is a perspective view of the cylinder part of FIG. 2, viewed from another direction. FIG. 4 is a cross-sectional view schematically illustrating the brake device for a vehicle according to an embodiment of the present disclosure. FIG. 5 is an enlarged cross-sectional view of a periphery of a vibration reduction part according to an embodiment of the present disclosure. FIG. 6 is an enlarged cross-sectional view of a periphery of a support part and screw shaft according to an embodiment of the present disclosure. FIG. 7 illustrates an operating state in which the piston part advances inside the cylinder part in the brake device for a vehicle according to an embodiment of the present disclosure. FIG. 8 illustrates an operating state in which the piston part retreats inside the cylinder part in the brake device for a vehicle according to an embodiment of the present disclosure.

Referring to FIG. 1 to FIG. 8, the brake device for a vehicle according to an embodiment of the present disclosure includes a cylinder part 200, a motor part 300, a screw shaft 400, a nut part 500, a piston part 600, a sleeve part 700, a bearing part 900, and a support part 1000, which are described in detail as follows.

The cylinder part 200 is disposed inside a housing part 100 and supports the torque generated when hydraulic pressure is formed due to the reciprocating movement of the piston part 600. The housing part 100 according to the present embodiment may be disposed in a hollow shape with an internal space, and may be press-fitted to the cylinder part 200.

The housing part 100 may be provided on the outside (left side of FIG. 1) of the cylinder part 200. The cylinder part 200 may be assembled to the housing part 100 so that the concentricity is regulated.

The cylinder part 200 is formed in a hollow shape. The sleeve part 700 having an operating section provided therein is disposed in one space (left side based on FIG. 1) inside the cylinder part 200 so that hydraulic pressure is formed by the pressurization of the piston part 600.

The motor part 300 is connected to the cylinder part 200, and various types of driving devices may be used within the technical concept of generating rotational power. The motor part 300 transmits rotational power (torque) to the screw shaft 400.

The motor part 300 includes a fixing part 310, a motor rotation part 320, and a motor bearing part 330.

The fixing part 310 is fixed to the housing part 100 and may have various shapes within the technical concept of changing the magnetic force by supplying power.

The fixing part 310 includes a fixing frame 311 fixed to one side (right side in FIG. 1) of the housing part 100 and a stator 312 that is installed on an inner surface of the fixing frame 311 facing the motor rotation part 320 and generates magnetic force.

The fixing frame 311 is connected to one side of the housing part 100, and the motor rotation part 320 is installed rotatably on the inside of the fixing frame 311.

The stator 312 that is an electromagnet is installed circumferentially on the inside surface of the fixing frame 311, and the magnetic flux changes by a control signal from a control part (not shown), thereby rotating the motor rotation part 320.

The motor rotation part 320 is connected to the screw shaft 400 to rotate together with the screw shaft 400, and may be modified into various shapes within the technical concept of rotation according to the change in magnetic force of the fixing part 310.

The motor rotation part 320 is installed rotatably on the inside of the fixing frame 311. The cross section of the motor rotation part 320 may have an approximately C-shape or U-shape, and may have a hollow shape.

The motor rotation part 320 includes a rotation frame 321 installed in a shape that surrounds one side (right side in FIG. 1) of the cylinder part 200 and a rotor 322 installed on the outer surface of the rotation frame 321 facing the fixing part 310 and having magnetic force.

A spline that meshes with the screw shaft 400 may be disposed in the rotating frame 321, specifically, on an inner surface of the rotating frame 321.

The motor bearing part 330 is installed between the fixing part 310 and the motor rotating part 320 to reduce friction generated when the motor rotating part 320 rotates. The rotor 322, which is a plurality of magnets installed in the circumferential direction of the rotating frame 321, rotates together with the rotating frame 321 by the change in the magnetic force of the stator 312.

A cover member 340 fixed to the fixing frame 311 is installed in a shape that surrounds the outer side of the end of the rotating frame 321 and blocks the inflow of foreign substances.

The screw shaft 400 is provided inside the cylinder part 200. The screw shaft 400 may be inserted in the longitudinal direction (left-right direction based on FIG. 1) of the cylinder part 200 and may be axially coupled to the cylinder part 200. A central axis of the cylinder part 200 and a central axis of the screw shaft 400 may coincide with each other.

The screw shaft 400 is fixed to the bearing part 900 by the support part 1000. The support part 1000 can rotatably support the screw shaft 400. The screw shaft 400 includes a screw body portion 410, a neck portion 420, a power transmission portion 430, and a coupling portion 450.

The screw body portion 410 is rotatably installed inside the cylinder part 200, and a spiral gear may be disposed in the longitudinal direction of the screw shaft 400. The screw body portion 410 is located inside the rotation frame 321 of the motor part 300.

The neck portion 420 protrudes from the outer surface of the rotation center of the screw body portion 410 to a first side (right side as shown in FIG. 1) and has a smaller diameter than the screw body portion 410.

The power transmission portion 430 extends from the free end of the neck portion 420 to the first side (right side as shown in FIG. 1) and has a larger diameter than the neck portion 420.

A spline may be formed along the circumferential direction on the outer surface of the power transmission portion 430 facing the rotating frame 321. Accordingly, in the absence of a cover portion 440 described later, the rotating frame 321 and the power transmission portion 430 may be engaged to transmit power.

The screw shaft 400 further includes the cover portion 440. The cover portion 440 is disposed to surround the neck portion 420 and the power transmission portion 430. The cover portion 440 may be interposed between the power transmission portion 430 and the rotating frame 321 to prevent metallic rattle noise from being generated.

On the outer surface of the cover portion 440, a spline may be formed along the circumferential direction of the cover portion 440 so that the cover portion 440 may be engaged with the rotating frame 321. The outer shape of the cover portion 440 may be the same as the outer shape of the power transmission portion 430.

A spline may be formed along the circumferential direction on the outer surface of the power transmission portion 430 facing the cover portion 440. Accordingly, the cover portion 440 and the power transmission portion 430 may be engaged to achieve power transmission.

The coupling portion 450 extends from the outer surface of the rotation center of the screw body portion 410 to a second side (left side in FIG. 1) and is rotatably coupled to the bearing part 900. The coupling portion 450 may be forcibly pressed into the bearing part 900 and coupled. The coupling portion 450 has the same diameter as or a smaller diameter than the screw body portion 410.

The nut part 500 is located inside the rotating frame 321 of the motor part 300 and is disposed inside the cylinder part 200. The nut part 500 may be connected to the outer surface of the screw shaft 400 via ball members B.

The screw shaft 400 may be coupled by penetrating the nut part 500. Because the ball members B are arranged between the inner surface of the nut part 500 and the spiral gear formed on the outer surface of the screw body portion 410, the rotational motion of the screw shaft 400 may be converted into linear motion through the nut part 500.

The nut part 500 may have an anti-rotation protrusion (not shown) formed on the outer surface, and the cylinder part 200 may have a moving groove (not shown) formed on the inner surface.

When the screw shaft 400 rotates, the anti-rotation protrusion of the nut part 500 is blocked from rotating by the moving groove, so that the nut part 500 does not rotate. Accordingly, the rotational motion of the screw shaft 400 can be converted into the linear motion of the nut part 500 by the anti-rotation protrusion and the moving groove.

Depending on the rotational direction of the screw shaft 400, the nut part 500 can reciprocate in the axial direction of the screw shaft 400. For example, when the screw shaft 400 rotates in a first direction, the screw shaft 400 moves forward, and when the screw shaft 400 rotates in a second direction, which is the opposite direction to the first direction, the screw shaft 400 moves backward.

The piston part 600 is coupled in a form that surrounds the outside of the nut part 500. The piston part 600 moves in the longitudinal direction of the cylinder part 200 in conjunction with the reciprocating movement of the nut part 500.

The piston part 600 includes a rod portion 610 and a head portion 620.

The rod portion 610 is disposed in a hollow shape and is located inside the rotating frame 321 of the motor part 300. The outer surface of the nut part 500 and the inner surface of the rod portion 610 may be screw-connected.

The head portion 620 may be disposed integrally with the rod portion 610. An outer diameter of the head portion 620 may be larger than the outer diameter of the rod portion 610.

The head portion 620 is formed in a ring shape, is located inside the housing part 100, and moves the operating fluid inside the sleeve part 700 toward ports 210 while reciprocating inside the sleeve part 700. Accordingly, the cylinder part 200 may form a double-acting hydraulic pressure according to the reciprocating movement of the piston part 600.

The sleeve part 700 is located inside the housing part 100 and disposed inside the cylinder part 200. The sleeve part 700 may induce the piston part 600 inserted therein to be moved.

The sleeve part 700 is disposed to surround the head portion 620 of the piston part 600. The ports 210 through which the operating fluid moves are disposed in regions in which the sleeve portion 700 is disposed on an outer surface of the cylinder part 200. The ports 210 may be provided at multiple points in the longitudinal direction of the cylinder part 200. The operating fluid moved according to the movement of the piston part 600 moves through the ports 210 and may implement the required braking pressure.

Cut-off holes 710 are disposed at the outer surface of the sleeve part 700 to communicate with the ports 210. A plurality of cut-off holes 710 are disposed to be spaced apart from each other along the circumference of the sleeve part 700. Accordingly, the operating fluid inside the sleeve part 700 can be discharged in the radial direction of the piston part 600.

The sleeve part 700 may be elongated in the longitudinal direction of the screw shaft 400. A front end 750 (left end based on FIG. 6) of the sleeve part 700 is disposed on the bearing part 900 side. The front end 750 of the sleeve part 700 includes a first facing portion 751 and a second facing portion 752.

The first facing portion 751 faces an outer ring part 920 of the bearing part 900 and contacts the outer ring part 920. The second facing portion 752 faces an inner ring part 910 of the bearing part 900 and is spaced apart from the inner ring part 910 by a predetermined distance D. Because the first facing portion 751 is in surface contact with the outer ring part 920, a relative movement between the bearing 900 and the sleeve part 700 can be restricted.

Because the inner ring part 910, which is the rotating part of the bearing part 900, and the second facing portion 752 of the sleeve part 700 are disposed to be spaced apart from each other, friction with the sleeve part 700 and vibration, noise, etc. caused by the friction can be reduced when the bearing part 900 rotates.

The first facing portion 751 and the second facing portion 752 may be formed in steps.

The front end 750 of the sleeve part 700 further includes a transition portion 752a connecting the first facing portion 751 and the second facing portion 752.

The transition portion 752a may be disposed to be gradually spaced apart from the bearing part 900 as it moves from the first facing portion 751 to the second facing portion 752. With reference to FIG. 6, the transition portion 752a is disposed to be inclined toward the right from the end of the first facing portion 751 and connected to the end of the second facing portion 752.

The first facing portion 751 and the second facing portion 752 may be disposed in a horizontal surface shape with respect to the bearing part 900, and the transition portion 752a may be disposed in a slanted surface shape with respect to the bearing part 900, thereby optimizing the stroke of the piston part 600.

The second facing portion 752 is disposed in a horizontal surface shape with respect to the bearing part 900, so that the internal space of the sleeve part 700 may not be reduced. Accordingly, the stroke of the piston part 600 moving in the internal space of the sleeve part 700 can be secured to a maximum extent, so that loss of the stroke of the piston part 600 can be prevented when forming the braking fluid pressure.

A maximum outer diameter of the second facing portion 752 may be equal to or larger than the maximum outer diameter of the inner ring part 910. In other words, the outermost point of the second facing portion 752 may be disposed at the same point in the outward direction as an outermost point 910a of the inner ring part 910 or further outward in the outward direction.

In FIG. 6, the diameter at the outermost point of the second facing portion 752 is larger than the diameter at the outermost point 910a of the inner ring part 910. As a result, the second facing portion 752 may be spaced apart from the inner ring part 910 by a predetermined distance D throughout the entire region.

The screw shaft 400 may tilt or shake about a central axis due to a load or clearance tolerance caused by the hydraulic pressure when the piston part 600 moves forward. The tilt or shake of the screw shaft 400 may occur with the joint portion of the coupling part 450 and the support part 1000 as the origin (center point).

When the screw shaft 400 shakes, an amplitude of the screw shaft 400 gradually increases as the screw shaft 400 moves away from the origin of the shake, and may be the largest on the side of the neck portion 420 that is the farthest from the origin of the shaking.

The brake device for a vehicle according to an embodiment of the present disclosure further includes a vibration reduction part 800.

In this embodiment, it is possible to prevent a significant increase in the amplitude of the screw shaft 400 or occurrence of resonance through the vibration reduction part 800. As a result, it is possible to prevent the power transmission portion 430 or the cover portion 440 from being damaged so that power is not normally transmitted from the motor part 300 to the screw shaft 400 or quality issues caused by noise and vibration occur.

A first side (left side as shown in FIG. 5) of the vibration reduction part 800 according to the present embodiment may be supported by the screw shaft 400 and a second side (right side as shown in FIG. 5) of the vibration reduction part 800 may be supported by the motor part 300. Accordingly, the vibration reduction part 800 may suppress the neck portion 420 of the screw shaft 400 from vibrating significantly outside the central axis of the screw shaft 400 within the rotating frame 321 of the motor part 300.

The neck portion 420 of the screw shaft 400 indirectly contacts the rotating frame 321 via the vibration reduction part 800. Therefore, when the brake device for a vehicle is operated, the relative displacement of the neck portion 420 of the screw shaft 400 with respect to the rotating frame 321 is reduced, thereby reducing the amplitude of the screw shaft 400.

The vibration reduction part 800 is elastically deformable while being supported by the screw shaft 400 and the motor part 300. As a result, when the screw shaft 400 shakes, the vibration reduction part 800 may be elastically deformed and absorb the vibration or shock due to the vibration of the screw shaft 400.

The vibration reduction part 800 may be a spiral coil. The vibration reduction part 800 may have a discontinuous ring shape. That is, the vibration reduction part 800 may be formed in a ring shape with one side of the outer circumference open, as shown in FIG. 2.

The vibration reduction part 800 has two ends, so that the vibration of the screw shaft 400 can be transmitted to the vibration reduction part 800 and dispersed to the outside through each end of the vibration reduction part 800. The second side of the vibration reduction part 800 may be disposed further away from the sleeve part 700 than the first side.

With reference to FIG. 5, a point where the vibration reduction part 800 comes into contact with the screw shaft 400 and a point where the vibration reduction part 800 comes into contact with the rotating frame 321 of the motor part 300 are disposed in an oblique direction. Accordingly, the vibration reduction part 800 may buffer vibration in all directions of 360 degrees with respect to the central axis of the screw shaft 400.

The vibration reduction part 800 may include a steel material. More specifically, the vibration reduction part 800 may be a stainless steel material. The vibration reduction part 800 may be a torsion spring or a twisting coil.

The first side of the vibration reduction part 800 is in contact with and supported by the stepped portion 411 at the connection portion between the screw body portion 410 and the neck portion 420. Because the stepped portion 411 is formed in a flat surface shape, the first side of the vibration reduction part 800 can be stably and elastically supported on the stepped portion 411.

The second side of the vibration reduction part 800 is in contact with and supported by the rotating frame 321 of the motor part 300. The second side of the vibration reduction part 800 is in contact with and supported by a tapered surface 325 of the rotating frame 321. Because the tapered surface 325 is formed in a flat surface shape, the second side of the vibration reduction part 800 can be stably and elastically supported on the tapered surface 325.

Because the screw shaft 400 is coupled to the nut portion 500 via the ball members B, a certain amount of vibration occurs so that performance degradation or a jamming phenomenon does not occur during operation. In the present embodiment, because the vibration reduction part 800 is disposed in the space where the vibration of the screw shaft 400 occurs, it is possible to effectively reduce the vibration of the screw shaft 400 when the vibration occurs without restricting the degree of freedom.

The vibration reduction part 800 may be disposed to surround the neck portion 420 of the screw shaft 400 not to interfere with the cover portion 440. The vibration reduction part 800 may be disposed not to come into contact with the inner surface of the neck portion 420.

The bearing part 900 is located on the inside of the housing part 100 and is provided on the inner end of the cylinder part 200.

The bearing part 900 is installed while the outer surface of the bearing part 900 and the outer surface of the sleeve part 700 are in contact with each other. The bearing part 900 is coupled with the screw shaft 400 in a form that surrounds the coupling part 450 of the screw shaft 400.

The bearing part 900 is in contact with the sleeve part 700, but the rotating portion of the bearing part 900 may not be in contact with the sleeve part 700. When the rotating portion of the bearing part 900 rotates, the rotating portion of the bearing part 900 and the sleeve part 700 can be prevented from rubbing against each other. As a result, the occurrence of impact noise can be suppressed when the brake device for a vehicle is operated, and shaft alignment compensation can be maintained, thereby reducing the NVH (Noise, Vibration and Harshness) phenomenon.

The bearing part 900 includes the inner ring part 910, a bearing ball 915, and the outer ring part 920.

The outer ring part 920 is in contact with the inner surface of the cylinder part 200 and is in contact with the sleeve part 700.

The inner ring part 910 is a rotating part of the bearing part 900 and is rotatably disposed on the inside of the outer ring part 920. The inner ring part 910 comes into contact with the coupling portion 450 of the screw shaft 400 and is disposed to be spaced apart from the second facing portion 752 of the sleeve part 700. The coupling portion 450 can be forcibly pressed into the inside of the inner ring part 910 and coupled to the inner ring part 910.

The bearing part 900 can support a load in an axial direction when hydraulic pressure is formed in the cylinder part 200 by the piston part 600 reciprocating in the axial direction of the screw shaft 400.

The brake device for a vehicle according to an embodiment of the present disclosure further includes a reaction force part 1100.

The reaction force part 1100 has a first side supported by the cylinder part 200 and a second side in contact with the sleeve part 700 to press the sleeve part 700 toward the bearing part 900.

The reaction force part 1100 may include a spring that is elastically deformable. The reaction force part 1100 provides a pressing force to the sleeve part 700 through an elastic restoring force after compression while being supported by the cylinder part 200. The front end 750 of the sleeve part 700 may always come in close contact with the bearing part 900 by the reaction force part 1100.

The reaction force part 1100 may be located in a flow path of the braking liquid, and may be disposed not to interfere with the flow of the braking liquid. The reaction force part 1100 may be a wave spring.

The support part 1000 is provided inside the cylinder part 200. The support part 1000 is inserted into the coupling part 450 and coupled to the screw shaft 400. The support part 1000 is screwed to the screw shaft 400. The bearing part 900 is fixed to the support part 1000. The support part 1000 may support the screw shaft 400 to be axially rotated on the central axis.

The support part 1000 includes a support bolt 1000A in a form of a bolt. The support bolt 1000A includes a bolt head 1010 and a bolt body 1020.

The bolt body 1020 of the support bolt 1000A is inserted into the coupling groove 451 of the coupling portion 450 of the screw shaft 400 and is screw-coupled to the inner surface of the coupling portion 450. A front end (a right end based on FIG. 6) of the bolt body 1020 may be disposed in the coupling groove 451 to be deeper than an end (a right end based on FIG. 6) of the bearing part 900.

Because the bolt body 1020 is inserted into the coupling portion 450 beyond the region of the bearing part 900 (refer to FIG. 6), a large screw fastening area between the bolt body 1020 and the coupling portion 450 may be secured. Accordingly, fastening robustness between the support part 1000 and the screw shaft 400 may be achieved.

The bolt head 1010 of the support bolt 1000A may be positioned so as to come into contact with the bearing part 900. As a result, the height of the bolt head 1010 is adjusted to manage the gap between parts, and a space for reducing the size of the device and system or changing the design of adjacent parts can be secured.

When the bolt body 1020 is screw-coupled into the coupling groove 451 of the coupling part 450, the front end (right end as shown in FIG. 6) of the bolt body 1020 may be spaced apart from the innermost bottom surface (rightmost side as shown in FIG. 6) of the coupling portion 450.

That is, a depth of the coupling groove 451 of the coupling portion 450 may be deeper than a length of the bolt body 1020 inserted into the coupling groove 451. Accordingly, a fastening force between the support part 1000 and the coupling portion 450 can be further increased.

When the screw shaft 400 rotates so that the piston part 600 moves forward in the main operation direction to form the braking pressure (refer to FIG. 7), the support part 1000 can rotate in the direction of being locked to the screw shaft 400. That is, when the screw shaft 400 rotates and the piston part 600 moves forward toward the sleeve part 700, the support part 1000 may rotate in the direction of being fastened to the screw shaft 400. Therefore, the fastening force between the support part 1000 and the screw shaft 400 can be secured even when the piston part 600 moves in the main operating direction.

Even when the support part 1000 rotates with respect to the screw shaft 400 during the forward movement of the piston part 600 in the main operating direction, the rotation direction of the support part 1000 becomes the direction in which the support part 1000 is further locked to the screw shaft 400 (a direction in which the support part 1000 is fastened).

Accordingly, it is possible to prevent the support part 1000 from being released from the screw shaft 400 when the piston part 900 moves forward in the main operating direction due to the rotation of the motor part 300, and thus, malfunctions such as control errors and system efficiency degradation can be prevented in advance. In addition, the error between the rotation amount of the motor part 300 and the forward amount of the piston part 600 may be managed or controlled.

The forward movement of the piston part 600 in the main operating direction means that the head portion 620 of the piston part 600 is moved forward toward the front end 750 of the sleeve part 700. When the driver presses a brake pedal, the piston part 600 is moved forward in the main operating direction.

When the screw shaft 400 rotates in a left screw direction and the piston part 900 moves forward toward the sleeve part 700, the support part 1000 may rotate in the left screw direction and be screw-coupled to the screw shaft 400.

In other words, the support part 1000 rotates in the left screw direction and is screw-coupled to the screw shaft 400, so when the screw shaft 400 rotates in the left screw direction and the piston part 900 moves forward toward the sleeve part 700, the support part 1000 has the relative rotation direction with respect to the screw shaft 400 in the left screw direction. Therefore, even when the support part 1000 rotates against the screw shaft 400 during the forward movement of the piston part 600 in the main operating direction, the rotation direction of the support part 1000 becomes the direction in which the support part 1000 is further locked to the screw shaft 400 (the direction in which the support part 1000 is fastened).

When the screw shaft 400 rotates in the right screw direction and the piston part 900 moves forward toward the sleeve part 700, the support part 1000 may rotate in the right screw direction and be screw-coupled to the screw shaft 400.

In other words, because the support part 1000 rotates in the right screw direction and is screw-coupled to the screw shaft 400, when the screw shaft 400 rotates in the right screw direction and the piston part 900 moves forward toward the sleeve part 700, the relative rotation direction of the support part 1000 with respect to the screw shaft 400 becomes the upward screw direction. Therefore, even when the support part 1000 rotates against the screw shaft 400 during the forward movement of the piston part 600 in the main operating direction, the rotation direction of the support part 1000 becomes the direction in which the support part 1000 is further locked in the screw shaft 400 (the direction in which it is fastened).

An operation process of a brake device for a vehicle according to an embodiment of the present disclosure having the above-described configuration is described as follows.

Referring to FIG. 7, when the motor part 300 is operated and the rotational force is transmitted to the screw shaft 400, the screw shaft 400 is axially rotated in a first rotational direction inside the cylinder part 200, and the nut part 500 is moved forward along the screw shaft 400 toward the sleeve part 700.

When the nut part 500 is moved toward the sleeve part 700, the piston part 600 coupled to the nut part 500 is moved forward in a straight line inside the cylinder part 200 in the same direction as the moving direction of the nut part 500 and forms a braking hydraulic pressure.

Referring to FIG. 8, when the motor part 300 is operated so that the screw shaft 400 is axially rotated in a second rotation direction, which is the reverse direction of the first rotation direction, the nut part 500 is moved backward along the screw shaft 400 in the opposite direction of the sleeve part 700.

When the nut part 500 is moved in a direction opposite to the sleeve part 700, the piston part 600 coupled to the nut part 500 may form the braking hydraulic pressure while moving back in a straight line inside the cylinder part 200 in the same direction as the moving direction of the nut part 500. Accordingly, as the piston part 600 is moved forward and backward in a straight line in the cylinder part 200, the double-acting hydraulic pressure is formed.

According to the brake device for a vehicle according to an embodiment of the present disclosure, the support part 1000 is screw-coupled to the screw shaft 400, so that the fastening force between the support part 1000 and the screw shaft 400 can be secured. The support part 1000 includes the support bolt screwed with the coupling portion 450, so that the fastening area between the support part 1000 and the screw shaft 400 is increased to achieve fastening robustness. In addition, it is possible to prevent the screw fastening between the support part 1000 and the screw shaft 400 from being released when the piston part 600 is moved in the main operating direction.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A brake device for a vehicle comprising:
a cylinder part;
a motor part that generates rotational power;
a screw shaft that is disposed inside the cylinder part and receives the rotational power of the motor part to be axially rotated;
a nut part coupled to the screw shaft and reciprocating in an axial direction of the screw shaft according to rotation of the screw shaft;
a sleeve part disposed between the cylinder part and the screw shaft;
a piston part coupled to the nut part and including a head portion reciprocating inside the sleeve part according to reciprocal movement of the nut part;
a bearing part disposed inside the cylinder part and coupled to the screw shaft; and
a support part that is screw-coupled to the screw shaft, comes into contact with the bearing part, and supports the screw shaft to be axially rotatable.

2. The brake device for a vehicle of claim 1,
wherein the support part includes a support bolt, and
wherein the support bolt is inserted into a coupling part of the screw shaft and is screw-connected to an inner surface of the coupling part.

3. The brake device for a vehicle of claim 2, wherein when the support bolt is screw-connected to the coupling part, a front end of the support bolt is spaced apart from an innermost bottom surface of the coupling part.

4. The brake device for a vehicle of claim 1, wherein when the screw shaft rotates and the piston part moves forward toward the sleeve part, the support part is rotatable in a direction in which the support part is fastened to the screw shaft.

5. The brake device for a vehicle of claim 1,
wherein when the screw shaft rotates in a left screw direction and the piston part moves forward toward the sleeve part, the support part rotates in the left screw direction and is screw-connected to the screw shaft, and
wherein when the screw shaft rotates in a right screw direction and the piston part moves forward toward the sleeve part, the support part rotates in right screw direction and is screw-connected to the screw shaft.

6. The brake device for a vehicle of claim 1, wherein the bearing part comprises:
an outer ring part that is in contact with an inner surface of the cylinder part and in contact with the sleeve part; and
an inner ring part that is rotatable on an inner side of the outer ring part, in contact with the screw shaft, and spaced apart from the sleeve part.

7. The brake device for a vehicle of claim 6, wherein the sleeve part comprises:
a first facing portion facing the outer ring part and in contact with the outer ring part; and
a second facing portion facing the inner ring part and spaced apart from the inner ring part.

8. The brake device for a vehicle of claim 7, wherein the first facing portion and the second facing portion are formed in steps.

9. The brake device for a vehicle of claim 7, wherein the sleeve part connects the first facing portion and the second facing portion and includes a transition portion disposed to gradually separate from the bearing part as goes from the first facing portion toward the second facing portion.

10. The brake device for a vehicle of claim 1, further comprising a reaction force part that presses the sleeve part toward the bearing part, including a first side supported by the cylinder part and a second side in contact with the sleeve part.
